(19) United States
(12) Patent Application Publication
(10) Pub. No.: US 2008/0032678 A1
(43) Pub. Date: Feb. 7, 2008

(54) CONTEXT BASED MARKETING

(76) Inventor: Narasimha SURESH, Bangalore (IN)

Correspondence Address: LOWE HAUPTMAN HAM & BERNER, LLP, 1700 DIAGONAL ROAD, SUITE 300, ALEXANDRIA, VA, 22314, US

(21) Appl. No.: 11/735,735

(22) Filed: Apr. 16, 2007

(30) Foreign Application Priority Data
Aug. 3, 2006 (IN) 1377/CHE/2006

(51) Int. Cl. H04Q 7/38

(52) U.S. Cl. 455/414.1

(57) ABSTRACT

A method and system for sending marketing and advertising material to users based on context of the users. The users provide data pertaining to them to a publisher. The publisher has at least one subscriber who intends to send its marketing and advertising material to the users. The publisher sends a message to the subscribers informing them about the users having a particular context. Subsequently, the publisher receives bids from one or more subscribers for sending their marketing and advertising material to the users. The bids are evaluated by the publisher to choose a best bid. Later, the publisher sends the marketing and advertising material of the subscriber who had placed the best bid to users of a given context.

The present application is based on, and claims priority from, IN Application Number 1377/CHE/2006, filed Aug. 3, 2006, the disclosure of which is hereby incorporated by reference herein in its entirety.

### FIELD OF THE INVENTION

The present invention relates to marketing and advertising in general. More particularly, the present invention relates to marketing and advertising based on contexts of mobile users.

### BACKGROUND AND PRIOR ART

For a business to be successful in today's world, marketing and advertising is extremely important. Companies have realized the importance of marketing and advertising, and are hence investing in it substantially. Companies are using various channels to reach users. The common channels used are television, internet, and mobile among others. Various marketing and advertising methods are being used to make it more efficient.

With the rapid growth of telecommunications worldwide, mobile commerce has become a reality. Mobile communication has also become an important channel for marketing various services. Over past few years, email messages have been used to market services. Service providers obtain the email ids from various sources including other service providers in various domains who have access to information of their customers. Similarly, mobile devices being common today, various service providers having access to mobile contact information of their customers can potentially share such information with other marketing agencies or service providers who would want to market their services. However, privacy concerns attached such sharing of mobile contact information is much more than it is to email id. At the same time, in order to market services, subscribers to such mobile contact information are also not guaranteed of their success through such sending campaigns to any available mobile contact information and they need to make sure that their marketing messages are reaching the right audience by ensuring that the audience to which they are sending messages belong to a context related to the marketing effort.

There are a few marketing mechanisms relating to mobile systems that try to take advantage of access to potential customers' contact information and the relevant ones are listed hereinafter.

Patent application WO03069428 discloses a mobile marketing system. The system facilitates linking of sales managers and sales representatives of the sales manager to a back office, which is a sales support center. The sales support center creates sales reports, reports for marketing and sales follow up, and other potential customer specific documentation. The system facilitates collection of client or potential client information by scanning through electronic media using software module. Alternatively, the information is collected by sales representatives.

Patent application WO03044703 discloses a system and method for creating personalized messages that will be sent to users' communication devices. The invention provides a mobile marketing system that monitors messages exchanged between the users' communication devices and messaging applications. Information collected during monitoring is utilized to create the personalized messages. However, personalizing messages to sell services is based on the users messaging trend. Additionally, the system and method is used in a telecommunication environment.

Patent application US20030126095 discloses a method and a system for generating marketing offer. The system includes a mobile virtual network operators system. The mobile virtual network operators system forms a single point of contact between customers and vendors. The system maintains databases for storing customers and vendors' information. The marketing offers are made based on context of the customers and the vendors. The context is based on previous sales history.

In the patent references provided here, the client information is directly accessible to companies that are eager to market their products and services. Additionally, the context of a potential client being used is either non-existent or very limited. And the aforementioned patent references do not talk about a marketing system based on context that enables marketing and advertising on mobile without having to share customer information with the agency that is looking to market its services.

In light of the foregoing discussion there is a need for providing a method and system for marketing and advertising based on context of mobile users rather than direct user information like mobile number, thereby ensuring that users' identity is secured. Besides, the method and system should ensure that users do not receive non relevant marketing and advertisement material.

### SUMMARY

An object of the present invention is to facilitate marketing and advertising based on context of users.

Another object of the present invention is to protect the identity of the users while providing their context information for marketing.

Yet another object of the present invention is to provide a transparent marketing channel in the form of a marketing and advertising system that enables publishers of context information of mobile users and subscribers of such context information to transact and market services to users.

Still another object of the present invention is to relieve the users from receiving non relevant marketing and advertisement material.

Accordingly, in one aspect, the present invention provides a method for marketing based on context of users. The invention facilitates sending marketing material to users. Enterprises that have access to customer information (publishers) use such information to build contexts of customers. Then the enterprise publishes the context information for other enterprises to buy such context information to send promotions. Enterprises that are interested in subscribing to such context information (subscribers), for sending their promotions to the users belonging to a particular context, send their bids to the publisher. The publisher reviews the bid and approves promotions if he is agreeable to the content and the bid. If the publisher is not agreeable with either the content of the promotion or the bid amount, he chooses to reject the offer or ask for a revision.

Another aspect of the invention provides a system to enable buying and selling of context information of mobile users. Publisher publishes the context information of mobile users for access. The system comprises of a data collection module, a database, a search module, a business module, a negotiation engine, a forwarding module and a billing module. The data collection module collects data from publishers and subscribers. The database stores context information of a plurality of mobile users. The database also stores the various promotions uploaded by subscribers to be sent to the mobile users as agreed between the publisher and subscriber. The search module receives search terms for conducting a search in the database. The search module enables subscribers to search the database using search terms and identify users belonging to a defined context. The business module stores and applies business rules for deciding on sending promotions to mobile users as selected by the subscriber. The business module acts as a rule engine and applies rules to decide on the best bid based on the cumulative effect of the available contexts, the subscription in terms of what a subscriber is willing to pay, and what the subscriber is willing to offer to the end customer using pre-defined weightage for each of the factors. The negotiation engine of the system allows for negotiation between publisher and subscriber to decide on pricing for the service. The forwarding module enables the forwarding of promotions the mobile users. The billing module keeps track of the promotions successfully sent and enables preparation of reports to be sent to subscribers for payment.

### BRIEF DESCRIPTION OF THE DRAWINGS

The present invention will be described in conjunction with the drawings appended to illustrate and not to limit the scope of the invention, wherein like designations indicate like elements, and in which:

FIG. 1a shows the network view of an exemplary environment in which the present invention may be practiced;

FIG. 1b shows the logical view of an exemplary environment in which the present invention may be practiced;

FIG. 2 is a block diagram illustrating various modules of the marketing and advertising system of the invention

FIGS. 3a and 3b is a flowchart illustrating a method for providing a context based marketing service, in accordance with various embodiments of the invention;

FIGS. 4a, 4b, and 4c is shows screens in accordance with an example implementation of the system of the invention.

### DETAILED DESCRIPTION OF THE INVENTION

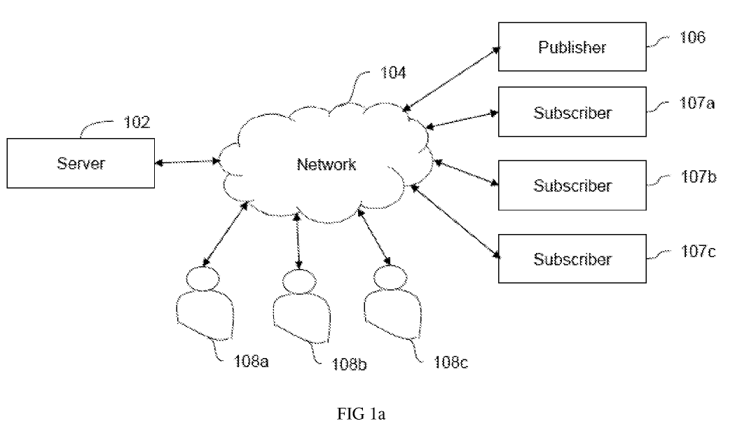

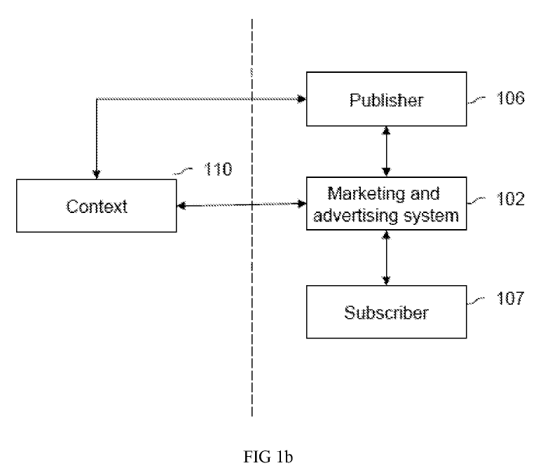

FIGS. 1a and 1b illustrates an exemplary environment in which the present invention may be practiced, in accordance with various embodiments of the invention. Environment in FIG. 1a comprises a server 102 comprising marketing and advertising system; plurality of subscribers 107; and plurality of users 108; a publisher 106; and a network connecting the server, the publisher, the plurality of users and the plurality of subscribers. The server 102 may be owned and operated by the publisher 106. Subscribers 107 may be companies who are eager to sell their products and services to users 108. Hence, subscribers 107 intend to send their marketing and advertising material to users 108 through the marketing and advertising system of the invention hosted on the server 102. Subscribers 107 communicate with the server 102 through network 104. Network 104 may be a wireless network, a wired network, or a combination of wireless and wired network. The server 102 communicates with the users 108 through network 104. The server 102 comprises of several modules in order to accomplish various objects of the present invention. FIG. 1b illustrates a logical view of interaction between various entities according to an embodiment in which, a publisher 106 receives context information of various users. Publisher publishes the context information through the marketing and advertising system hosted on the server 102. The marketing and advertising system of the invention stores the context information 110 of consumers in a database. Subscribers 107 may interact with the system and request the publisher to send their marketing and advertising material to users 108 according to the context chosen. In an embodiment of the invention, subscribers 107 interact with the publisher through the system and negotiate on the pricing for the marketing and advertising service provided by the system. In another embodiment, instead of one publisher, the marketing and advertising system may support more than one publisher to publish context information of a plurality of users and manage the context information that he published.

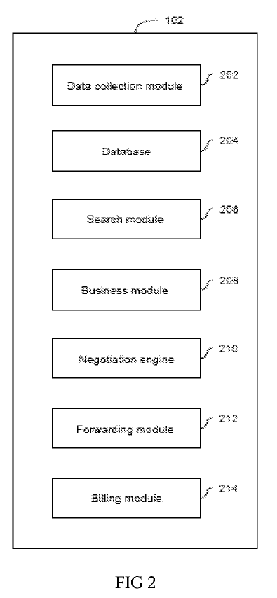

FIG. 2 is a block diagram illustrating various modules of the marketing and advertising system hosted on the server 102, in accordance with various embodiments of the invention. The marketing and advertising system includes a data collection module 202, a database 204, a search module 206, a business module 208, a negotiation engine 210, a forwarding module 212 and a billing module 214. Data collection module 202 collects information pertaining to users 108. The data may include but is not limited to age, gender, residential address, office address, telephone numbers, and electronic mailing address of users 108. The data collected depends on the context in which the publisher got the information of the users. For example, if the publisher is a cinema owner, then he would have information about the type of movie that a user is watching or going to watch, the time at which a consumer is going to watch the movie etc. The data collected is stored in a database 204. A subscriber may search the database using the search module 206 to find potential customers that he could target by sending promotion material through the marketing and advertising system. Alternatively, the publisher can search for contexts and inform all subscribers registered with the system about the availability of context of users that can be targeted for promotions.

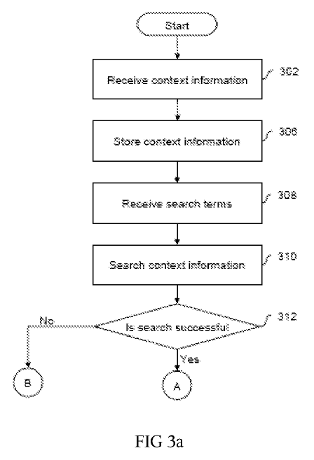

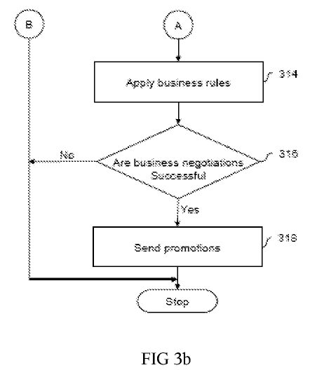

FIGS. 3a and 3b is a flowchart illustrating a method for providing a context based marketing service, in accordance with various embodiments of the invention. At step 302, data pertaining to context of users 108 is collected. The data is collected by data collection module 202. In an embodiment of the invention users 108 may furnish their data while applying for a credit card. The data may be collected from an authority to which users 108 furnish their data. Alternatively, the data may be directly provided to the data collection module 202. The data may include but is not limited to name, age, gender, residential address, office address, telephone numbers, and e-mail ID, of users 108. A context may be for example, number of male users within an age group of 25 to 30 who applied for credit card in Bangalore. The context and data pertaining to each of the users 108 is stored in the database at step 306. The database is accessible to the publisher. The database may be searched to identify users 108 having a defined context. At step 308, search module 206 receives search terms for searching in the database. The search terms may be specified by the publisher. In an alternate embodiment the search terms may be defined by subscribers 107. At step 310, the search is conducted by search module 206. Subsequently, the search result is checked at step 312. If the search result is satisfactory then step 314 is conducted. However, if the search result is not satisfactory then a new search may be conducted by using new search terms. Alternatively, the search may be abandoned.

If the search result is satisfactory, business rules are applied at step 314. In an embodiment of the invention the business rules are applied by business module 208. Successful search results in a results page that indicates the number of users 108 falling under a context. However, the contact information of the users 108 is not revealed to the subscribers 107. Thereafter, the subscribers 107 may send their bids to the publisher for sending their marketing and advertising material to the users 108. The publisher 106 may choose to send the marketing and advertising material of the subscriber 106a placing a best bid. The best bid may be decide based on the money that the publisher would receive by sending the marketing and advertising material to the users 108. The best bid may also be decided based on the cumulative effect of the available contexts, the subscription in terms of what a subscriber is willing to pay for the contexts, and what the subscriber is willing to offer to the end customer. In effect the best bid is based not necessarily only on the publishers interest, it can also be based on end consumers interest. In an embodiment of the invention, negotiations might occur between the publisher 106 and subscribers 107 enabled by the negotiation engine 210. In an embodiment of the invention, business module 208 has computer instructions for receiving bids from subscribers 107, and for selecting the best bid. Again the best bid may also be decided based on the cumulative effect of the available contexts, the subscription in terms of what a subscriber is willing to pay for the contexts, and what the subscriber is willing to offer to the end customer. Subsequently, at step 316, the status of the negotiation is checked. If the negotiation is successful, at step 318 marketing and advertising material of the subscriber 107 who has placed the best bid is sent to users 108. The material is sent by the forwarding module 212. The material sent could be in the form of discount coupons or simple promotional material. The billing module 214 of the marketing and advertising system keeps track of material sent on behalf of subscribers and makes sure that those subscribers receive the confirmation message of the delivery of material to users and also that the subscribers are sent reports to alert for payments to be made in accordance with the negotiations made earlier.

### EXAMPLE

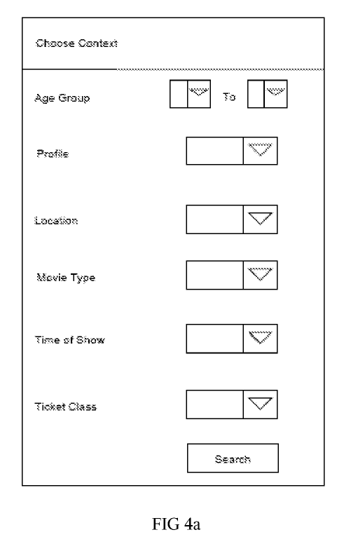

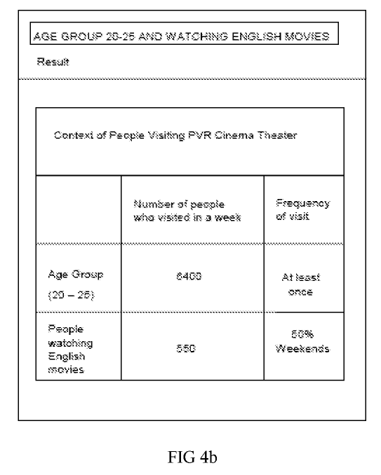

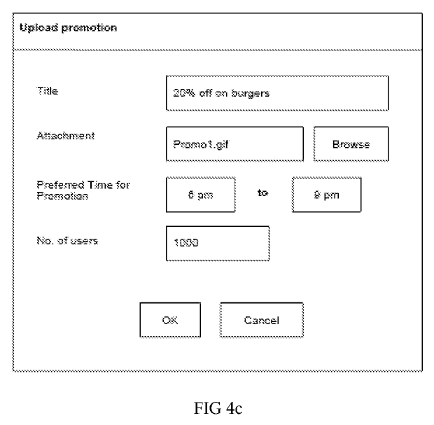

FIGS. 4a and 4b is an exemplary environment in which the present invention may be practiced, in accordance with various embodiments of the invention. In an embodiment of the invention, data is collected form users 108 who book movie tickets in a movie ticket booking facility. The data may include age, gender, and contact information of the users 108. The context information pertaining to each of the users 108 are stored in the database as published by the publisher. Later, the publisher may search in the database for users 108 belonging to a particular context. FIG. 4a illustrates a search interface used by the publisher to search for the users 108 having the particular context. The context may be for example users 108 of a certain profile who are under a certain age group. Further, the location of the users 108 may be specified. Additionally, type of movie, class of ticket, and the time of the show may be specified for carrying the search. In another embodiment of the invention, one or more of the search criteria may be specified. The search criteria is received by search module 206. Subsequently, search module 206 performs a search in the database, and provides a result on a graphical user interface. FIG. 4b, illustrates a result that is generated by the search. Later, the publisher 106 may send a message to one or more subscribers 107. The message informs the subscribers 107 about number of users having a particular context. The subscribers 107 may send their bids to the publisher for sending their marketing and advertising material to the users. The bids are received by business module 208. Business module 208 evaluates the bids, and selects a best bid. In an embodiment of the invention, the best bid may be selected based on manual evaluation of the bids using the negotiation engine. The best bid may be decided based on the cumulative effect of the available contexts, the subscription in terms of what a subscriber is willing to pay for the contexts, and what the subscriber is willing to offer to the end customer using pre-defined weightage assigned to each of the factors. After selection of the bids through negotiation enabled by the negotiation engine or the business module, forwarding module 212 sends material of the subscriber 107 who had placed the best bid. Subsequently, the billing module 214 bills the subscriber 107 for sending the material to the users.

In an embodiment of the invention, subscribers 107 may provide search terms for identifying users 108 having a defined context. Subscribers 107 may enter the search terms in a graphical user interface. The graphical user interface may be similar to the graphical user interface that is illustrated in FIG. 4a. The search terms are received by search module 206. Thereafter, search module 206 runs a search in the database. The result of the search is presented to subscriber on the graphical user interface. The result indicates the number of users 108 who belong to the defined context. However, contact information of users 108 is not presented to subscriber. If subscriber is not satisfied with the results, the subscriber may alter the search terms, and perform a new search. Alternatively, subscriber may abandon the search. However, if subscriber is satisfied with the result, subscriber may send a message to the publisher. The message may be for example, requesting the publisher to send subscriber's marketing and advertising material to users 108 having the defined context. Subsequently, the publisher may send a quotation in response to the request. Thereafter, subscriber may accept the quotation, and request the publisher to send the marketing and advertising material to users 108. Alternatively, subscriber may negotiate with the publisher to make changes in the quotation. Later, if the negotiation is successful, the publisher instructs the system to send the marketing and advertising material to users 108. Subscriber will be billed accordingly. The billing is tracked and performed by the billing module 214, which sends confirmation messages upon delivery of material to users and sends billing reports to subscribers 107.

FIG. 4C illustrates an interface that can be used to upload marketing and advertising material by the subscriber for consideration by the publisher. Once the negotiations between a subscriber and the publisher 106 are successful, the publisher 106 may access the material uploaded by the subscriber and review it for appropriateness before sending the material to the number of users as indicated belonging to the context selected by the subscriber. The figure shows an image being uploaded. Alternatively, the material could be any combination of text, video and audio based material depending on the technology supported by the system.

Various embodiments of the invention provide an advantage that facilitates marketing and advertising based on context of users. Additionally, the users are relieved from receiving non relevant marketing and advertisement material.

Various embodiments of the invention provide an advantage that protects the identity of the users. The contact information of the users is not revealed to the subscribers.

Various embodiments of the invention provide an advantage that a publisher providing the channel for marketing and advertising make optimum profit.

Although various units of publisher module have been illustrated as separate units, it will be apparent to a person skilled in the art that these units can be implemented as a single unit.

While the various embodiments of the invention have been described, it will be clear to a person skilled in the art that the invention is not limited to these embodiments only. Various equivalents, modifications and changes can be made to the invention without deviating from the spirit and scope of the invention as described in the claims.

What is claimed is:

1. A method of marketing based on context of mobile users, the method comprising the steps of:
a. publisher publishing context information of various mobile users;
b. one or more subscribers placing bids for sending marketing and advertising material to users belonging to a context as selected by the subscribers;
c. publisher accepting bids from one or more subscribers for sending the subscribers' material to users of the given context; and
d. publisher sending the material to the users by applying business rules, where the material is given by the subscribers and approved by the publisher.

2. A method as in claim 1, wherein the step of selecting the subscriber's bids by selecting the best bid is done manually by publisher.

3. A method as in claim 1, wherein the step of selecting the subscriber's bids by selecting the best bid is done automatically.

4. A method as in claim 2, wherein the best bid is decided based on the cumulative effect of available contexts, the subscription in terms of what a subscriber is willing to pay for the contexts, and what the subscriber is willing to offer to the end customer using pre-defined weightage for each of the factors.

5. A method as in claim 3, wherein the best bid is decided based on the cumulative effect of available contexts, the subscription in terms of what a subscriber is willing to pay for the contexts, and what the subscriber is willing to offer to the end customer using pre-defined weightage for each of the factors.

6. A method as in claim 1, the method further comprising the steps of:
a. publisher presenting a quotation for sending marketing and advertising material for a particular context and business rules specified by a subscriber
a. subscriber that receives the quotation negotiating for a better quotation with the publisher
b. publisher and subscriber agreeing on a final price

7. A method as in claim 1, the method further comprising the steps of:
a. sending a confirmation message to the subscriber whose material is delivered to users according to the context and business rules defined by the subscriber
c. tracking the subscribers who are yet to make the payment and sending them billing reports to ensure timely payments

8. A method as in claim 1, where personal information of users is not shared between the publisher and subscribers.

9. A method as in claim 1, the method further comprising the step of publisher informing various subscribers about the availability of user information, the information being in the form of a context.

10. A method as in claim 1, the method further comprising the step of subscribers searching for context of users that is of interest to the subscribers.

11. A computer program product for marketing based on context of mobile users, the computer program product performing the steps comprising:
a. a publisher publishing context information of various mobile users;
d. one or more subscribers placing bids for sending marketing and advertising material to users belonging to a context as selected by the subscribers;
e. publisher accepting bids from one or more subscribers for sending the subscribers' material to users of the given context; and
f. publisher sending the material to the users by applying business rules, where the material is given by the subscribers and approved by the publisher.

12. A computer program product as in claim 11, wherein the best bid is decided based on the cumulative effect of available contexts, the subscription in terms of what a subscriber is willing to pay for the contexts, and what the subscriber is willing to offer to the end customer using pre-defined weightage for each of the factors.

13. A computer program product as in claim 11, the computer program product further comprising instructions to perform the steps comprising:
a. publisher presenting a quotation for sending marketing and advertising material for a particular context and business rules specified by a subscriber;
b. subscriber that receives the quotation negotiating for a better quotation with the publisher; and
c. publisher and subscriber agreeing on a final price.

14. A computer program product as in claim 11, the computer program product further comprising instructions to perform the steps comprising:
a. sending a confirmation message to the subscriber whose material is delivered to users according to the context and business rules defined by the subscriber; and
b. tracking the subscribers who are yet to make the payment and sending them billing reports to ensure timely payments.

15. A computer program product as in claim 11, further comprising instructions to perform the step of publisher informing various subscribers about the availability of user information, the information being in the form of a context.

16. A computer program product as in claim 11, further comprising instructions to perform the step of subscribers searching for context of users that is of interest to the subscribers.

17. A system for sending marketing material to users, the users provide information to a publisher, the publisher has at least one subscriber, the at least one subscriber intends to market one or more of its products and services to the users, the system comprising, a publisher module, wherein the publisher module comprises:
a. a data collection module, the data collection module collects information from the users;
b. a database, the database storing the context information of users, and marketing and advertising material provided by subscribers along with publisher and subscribers' information;
c. a search module, the search module searches the database using search terms;
d. a business module, the business module for storing business rules;
e. a negotiation engine, the negotiation engine enabling negotiation between publishers and subscribers;
f. a forwarding module, the forwarding module for sending the marketing and advertising material to the users; and
g. a billing module, the billing module ensuring sending of confirmation messages to subscribers upon successful delivery of material to users, and sending of billing reports to subscribers.

18. The system according to claim 17, further comprising a graphic user interface, the graphic user interface to enable publishers and subscribers to interact with the system.
